(19) United States
(12) Patent Application Publication
(10) Pub. No.: US 2025/0045490 A1
(43) Pub. Date: Feb. 6, 2025

(54) Integrated Design Optimization and Material and Subassembly Selection using Machine Learning

(71) Applicant: Wisconsin Alumni Research Foundation, Madison, WI (US)

(72) Inventors: Saketh Sridhara, Madison, WI (US); Aaditya Chandrasekhar, Madison, WI (US); Krishnan Suresh, Middleton, WI (US)

(21) Appl. No.: 18/228,202

(22) Filed: Jul. 31, 2023

(51) Int. Cl. G06F 30/27; G06F 30/17

(52) U.S. Cl. CPC G06F 30/27; G06F 30/17

(57) ABSTRACT

A system for optimizing physical designs provides integrated optimization of design geometry, design materials, and design subassemblies by mapping a catalog of actual or available construction materials and subassemblies to a differentiable representation tractable for computerized optimization. New subassemblies may be generated by using the differential representation in conjunction with a decoder trained on the actual or available subassemblies.

### STATEMENT REGARDING FEDERALLY SPONSORED RESEARCH OR DEVELOPMENT

This invention was made with government support under 1561899 awarded by the National Science Foundation and under N00014-21-1-2916 awarded by the NAVY/ONR. The government has certain rights in the invention.

### CROSS REFERENCE TO RELATED APPLICATION

### Background of the Invention

The present invention relates to systems for modeling physical structures and optimizing their design and, in particular, to an optimizing system that integrates the optimization both of the geometric properties and constituent materials and subassemblies of such structures.

Significant advances in the design of physical structures have been realized by computer optimization of such structures. These optimizations may use a parameterized model of the structure, for example, providing a geometric description of the structure, and then designating certain dimensions (objective variables) for optimization. For example, in the design of a simple beam, a model of the beam may be constructed having geometric parameters defining the dimensions of the beam. Objective variables are then identified for optimization, for example, beam volume, and an optimization goal (an objective function) is developed, for example, reducing beam volume, as well as optimization limits, for example, maximum stresses (constraints). The computer then performs an optimization to yield specific geometric parameters of the objective variables describing an optimized beam minimizing the beam volume without exceeding a stress limit.

Typically, designing a physical structure requires not only a selection of geometric parameters but also the selection of a material from which the structure will be constructed. For many mechanical designs, standard subassemblies such as fasteners, bearings, springs, and the like must also be selected. The these selections are highly interdependent, meaning that one cannot be evaluated in isolation from the other preventing, for example, simply combining an independent optimization of a material without regard to the geometry or subassemblies and an optimization of the geometry without regard to the material and subassemblies.

Further, while the geometric parameters are typically continuous, that is being variable over a continuous range, the material parameters are typically linked with discrete materials and subassemblies are limited to discrete catalog items, making it difficult to optimize materials using classic gradient-based optimization which expects continuous variables. Simply treating material parameters or subassemblies as continuous variables is not a viable solution to the extent that invites an identification of material parameters that do not match existing materials, for example, materials having the maximum value of Young's modulus or tensile strength within the range of materials and the minimum values of cost or density within the range of materials even though such material does not exist.

### SUMMARY OF THE INVENTION

The present invention provides a way to integrate the optimization of geometry, material, and subassemblies that respects the limitations of real materials and product offerings. For this purpose, the invention uses machine learning techniques to create a differentiable representation fit to actual materials and subassemblies using a training set of a material catalog and a subassembly catalog. This differentiable representation may then be used with the continuous surface described by geometric parameters to perform a simultaneous optimization of geometric parameters, material parameters, and subassembly parameters.

The ability to construct a differentiable representation of subassemblies also permits generative design of new subassemblies by moving through that differentiable representation to generate a smoothly varying set of subassembly designs.

In one embodiment, the invention provides an optimizer for physical structures having an assembly of subassemblies constructed of materials, the optimizer including a parametric model of the assembly having geometric parameters to be optimized, a first machine learning decoder having weights trained with multiple different mechanical subassemblies, and a second machine learning decoder having weights trained with multiple different materials received by an encoder to encode the multiple material parameters, each of the machine learning decoders operating on the first and second differentiable representation of subassemblies and materials respectively. An optimizer uses the parametric model, an objective function, and one or more constraints to vary the geometric parameters and decoded material parameters applied to the parametric model to optimize the geometric parameters and material of the given structure.

It is thus a feature of at least one embodiment of the invention to provide a method of simultaneous optimization of multiple discrete machine design parameters including material and subassemblies together with geometric optimization.

The optimizer may further include a first catalog of subassemblies linked to subassembly material parameters and a second catalog of materials linked to multiple material parameters and the optimizer may employ: (1) a first step of optimizing the subassembly parameters of the given structure to a first coordinate in the first differentiable representation and optimizing the material parameters of the given structure to a second coordinate in the second differentiable representation, and (2) a second step of identifying a closest subassembly to the first coordinate and a closest material to the second coordinate from the first and second catalogs of materials respectively.

It is thus a feature of at least one embodiment of the invention to provide optimization output that is realizable using available materials and subassemblies.

The optimizer may further perform a third step of using the parametric model and objective function and one or more constraints to optimize the physical dimensions of the given structure using the material parameters of the closest material and/or the subassembly parameters of the closest subassembly.

It is thus a feature of at least one embodiment of the invention to produce a collective optimization that respects available materials and subassemblies.

The optimizer may further output a display representing the differentiable representation with subassemblies of the first catalog superimposed on that representation at corresponding locations in the differentiable representation; and/or similarly outputting a display representing the differentiable representation with materials of the second catalog superimposed on that representation at corresponding locations in the differentiable representation.

It is thus a feature of at least one embodiment of the invention to provide a dimensionless equivalent to an Ashby chart grouping materials and subassemblies according to the machine learning model such as may provide insight, for example, into gaps in a catalog of subassemblies.

The first catalog of subassemblies provides subassembly parameters selected from the group of bearings, springs, and fasteners.

It is thus a feature of at least one embodiment of the invention to provide a more comprehensive optimization process that can look at common subassembly types.

In one embodiment, the invention offers a mechanical subassembly synthesis apparatus using a machine learning decoder having weights trained with a training set of multiple different subassemblies and receiving a differentiable representation of subassembly parameters. An electronic computer receives a coordinate of the differentiable representation and applies it to the machine learning decoder to provide subassembly parameters.

It is thus a feature of at least one embodiment of the invention to provide a design tool that allows for a generation of smoothly varying subassembly designs, for example, selected to fill a gap in available of subassemblies.

The electronic computer may further display a visual representation of the differentiable representation and receive a coordinate identified with respect to the visual representation.

It is thus a feature of at least one embodiment of the invention to provide an intuitive user interface to allow navigation through possible subassembly designs.

The visual representation may further include a display of a particular subassembly parameter value mapped to the differentiable representation.

It is thus a feature of at least one embodiment of the invention to permit the generation of novel subassemblies based on a desired subassembly parameter value.

These particular objects and advantages may apply to only some embodiments falling within the claims and thus do not define the scope of the invention.

### BRIEF DESCRIPTION OF THE DRAWINGS

FIG. 1 is a block diagram of one embodiment of the optimizing system of the present invention showing a non-optimized parametric model that may be simultaneously optimized for geometric parameters and material parameters using a trained neural network and showing the training of a portion of that neural network as part of that optimizing system;

FIG. 2 is a flowchart of the steps executed by the optimizing system of FIG. 1 which may also provide a visualization of a catalog of materials;

FIG. 3 is a representation of a visualization that may be generated by the optimizer of FIG. 1;

FIG. 4 is a block diagram of a processor and memory system providing one method of implementing the optimizing system of FIG. 1;

FIG. 5 is a figure similar to FIG. 1 showing expansion of the system of FIG. 1 for simultaneous optimization of a material geometric parameter and subassembly;

FIG. 6 is a geometric representation of the differentiable representation of subassemblies showing the ability to generate subassemblies by selecting coordinates within the differentiable representation.

### DETAILED DESCRIPTION OF THE PREFERRED EMBODIMENT

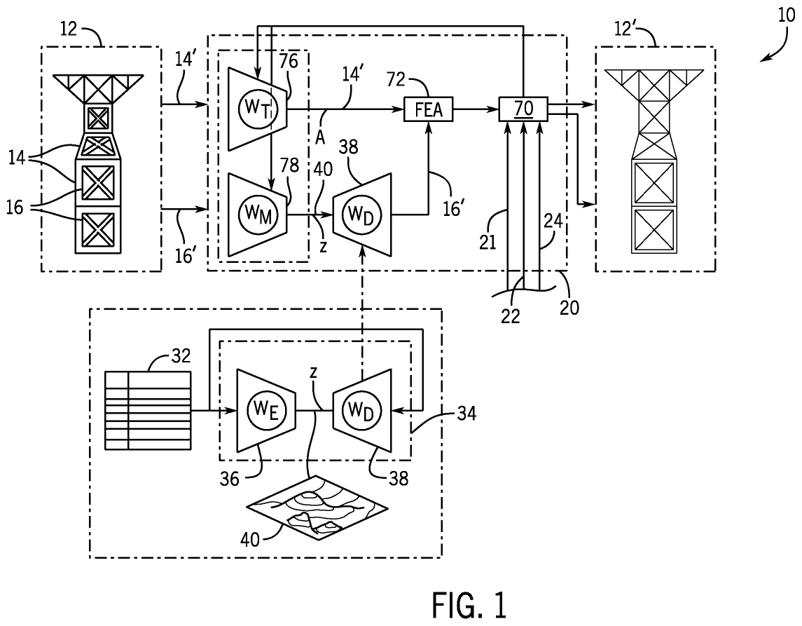

Referring now to FIG. 1, a system 10 for optimizing physical structures may work with a parametric model 12 of the physical structure (for example, a truss structure as shown) having geometric parameters 14 describing the dimensions of the individual truss elements (e.g., length and cross-sectional area) and their assembly (attachment points, angles, etc.). The parametric model 12 may also include material parameters 16 (for example, steel, aluminum, etc.) from which the truss elements are fabricated.

Selected geometric parameters 14′ (for example, truss element cross-sectional area) and selected material parameters 16′ (for example, material strength, cost, and weight) may be designated as objective variables 21 to be optimized by an optimizer 20 according to a received objective function 22 and various constraints 24 as will be discussed below. The result is an optimized parametric model 12′, for example, having improved cost or weight while meeting, for example, a designated objective variable 21 of strength.

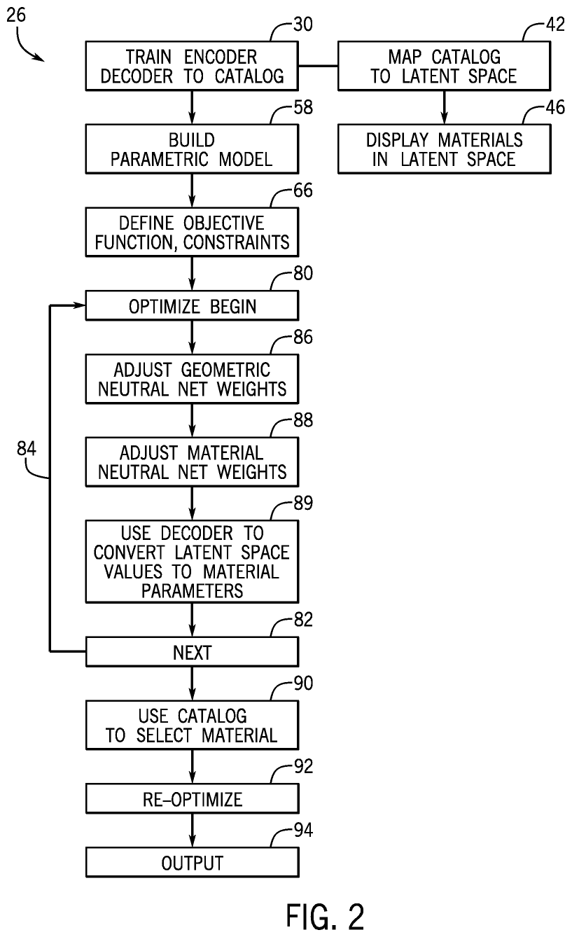

Referring now to FIGS. 1 and 2, the optimization process 26 performed by the optimizer 20 may start as indicated by process block 30 by obtaining a catalog of materials 32, for example, indexed to material identifiers (for example, A286 iron) and providing material parameters such as strength, cost, and density. A simplified catalog for this truss example is shown below in Table number I and provides various material identifiers in different rows linking those rows together with Young's modulus (E), cost per unit mass (C), mass density (p), and yield strength (Y).

TABLE I

| Material | Class | E [Pa] | cost C[$/kg] | ρ[kg/m³] | Y [Pa] |
|---|---|---|---|---|---|
| A286 Iron | Steel | 2.01E+11 | 5.18E+00 | 7.92E+03 | 6.20E+08 |
| AISI 304 | Steel | 1.90E+11 | 2.40E+00 | 8.00E+03 | 5.17E+08 |
| Gray Cast Iron | Steel | 6.62E+10 | 6.48E−01 | 7.20E+03 | 1.52E+08 |
| 3003-H16 | Al Alloy | 6.90E+10 | 2.18E+00 | 2.73E+03 | 1.80E+08 |
| 5052-0 | Al Alloy | 7.00E+10 | 2.23E+00 | 2.68E+03 | 1.95E+08 |
| 7050-T7651 | Al Alloy | 7.20E+10 | 2.33E+00 | 2.83E+03 | 5.50E+08 |
| Acrylic | Plastic | 3.00E+09 | 2.80E+00 | 1.20E+03 | 7.30E+07 |
| ABS | Plastic | 2.00E+09 | 2.91E+00 | 1.02E+03 | 3.00E+07 |
| PE HD | Plastic | 1.07E+09 | 2.21E+00 | 9.52E+02 | 2.21E+07 |

More generally, the catalog of materials 32 need not be limited to these parameters or bulk material properties and may include more complex materials such as springs, gears, and the like characterized by these or other material properties (e.g., spring constant, tooth pitch, etc.). Thus, as used herein, materials, and material parameters and the like should be understood to include not only bulk material properties as shown in the above table but also properties of construction elements such as springs, gears, and bearings where the properties may be arbitrary parameters defining those construction elements independent from its construction material.

This catalog of materials 32 is used to provide a training set for a machine learning neural network system 34 having a series-connected encoder 36 and a decoder 38. The neural network system 34, for example, may be a variational auto encoder (VAE) such as is described at Diederik P Kingma and Max Welling, “An introduction to variational autoencoders”, arXiv preprint arXiv: 1906.02691, 2019, hereby incorporated by reference.

In this example, the encoder 36 may receive a four-dimensional input of E, C, p, and Y and may map this input to a two or multidimensional latent space 40 (Z) using a network of 250 neurons associated with a ReLU activation function and weights (w_{E}). The decoder 38 may likewise have a set of 250 fully connected neurons associated with weights (w_{D}) to map the latent space 40 back to the four dimensions of E, C, p, and Y exhibiting slight variations in values from the corresponding input values as a result of the compression and decompression process of the neural network system 34. Desirably, these variations in value will be a few percent and typically less than 10%.

The weights (w_{E}) and (w_{D}) are developed by conventional neural network training to minimize the above variations and performed by successively providing different rows of the catalog of materials 32 to the encoder 36 and decoder 38 and back propagating errors (the variations) to adjust the weights.

The latent space 40 has the property of being differentiable as opposed to the discontinuous values of the catalog of materials 32 and thus is well adapted to a variety of optimization techniques.

The decoder 38 is then used in the optimizer 20, as will be discussed below, as represented by its weights (w_{D}). Generally, the trained decoder 38 per process block 30 may be reused for a variety of different optimization problems using the materials of the catalog 54 and will not be limited to the particular parametric model 12.

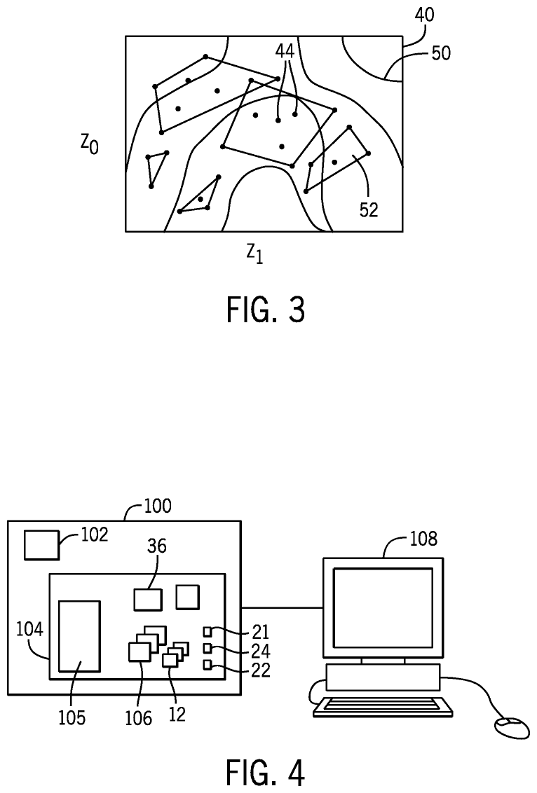

Referring now to FIGS. 2 and 3 and indicated by process block 42 of FIG. 2, the encoder 36 may also be used to map individual material identifiers (represented by the first column of the catalog of materials 32) to points 44 in the latent space 40 and these points 44 displayed over representation of the latent space 40 (per process block 46) to provide insight into the relationship between different materials which will also be referenced later in the optimization process as will be discussed. In the display, the latent space 40 may be represented by isovalue lines 50 or colors or the like and the points 44 may be clustered, for example, by cluster boundary lines 52 (or similar techniques such as shading) to be grouped according to categories such as steel, aluminum, plastic, and the like.

Referring again to FIGS. 1 and 2, for a given optimization as indicated by process block 58, a parametric model 12 is constructed, for example, of a finite element model of the desired parametric model 12, providing the geometric parameters 14 and material parameters 16 discussed above and designating objective variables 21 (being geometric parameters 14′ or material parameters 16′) which will be optimized. An objective function 22 and the necessary optimization constraints 24 are then defined at process block 66.

Referring again to FIG. 1, the objective function 22, the constraints 24, and the objective variables 21 will be provided to an optimizing engine 70 of the optimizer 20 which will serve to vary the objective variables 21 to maximize the objective function 22 within the constraints 24. The optimizer 20 works in an iterative fashion indicated by process blocks 80 and 82 and iteration loop 84. For this purpose, the optimizer 20, in conjunction with the analyzer 72, receives the current iteration of the geometric parameters 14′ and the material parameters 16′ and determines a value of the objective function that will be maximized by the optimizing engine 70.

In one embodiment, the current geometric parameters 14′ and material parameters 16′ are obtained, respectively, from a respective geometry neural net 76 and material neural network 78, the latter providing an input to decoder 38 which outputs the necessary material parameter 16′. More specifically, within the iteration loop of process blocks 80 and 82, at process block 86, the optimizer 20 incrementally adjusts the weights w_{T} of the geometry neural network 76 to produce output sent to the analyzer 72 and, at process block 88, adjusts the weights w_{M} of the material neural network 78 to produce outputs that are sent to the decoder 38 (per process block 89) which in turn provides output sent to the analyzer 72.

As discussed above, the geometry neural network 76 is parameterized by weights w_{T}, and the material neural network 78 is parameterized by weights w_{M}, and in one example, both the geometry neural network 76 and the material neural network 78 may be simple feed-forward neural networks with two hidden layers with a width of 20 neurons, each containing an ReLU activation function. In the above truss example, the input to the geometry neural network 76 is a unique identifier for each truss element, for example, a vector of coordinates of the truss element centers. The output layer of geometry neural network 76 consists of N neurons where N is the number of truss members, activated by a Sigmoid function, to generate a vector O_{T} of size N whose values are in [0, 1]. The output is then scaled as A←Aₘᵢₙ+O_{T} (Aₘₐₓ−Aₘᵢₙ) to satisfy the area constraints 24.

The material neural network 78 may be similar to geometry neural network 76 in construction, for simplicity, and may also receive a vector input corresponding to each truss element; however, in a simple case where a single material is used for all the truss elements, a single scalar identifier 1 may be received as its input. The output layer consists of two output neurons activated by Sigmoid functions. The outputs O_{M} are scaled as z←−3+6O_{M}, resulting a coordinate in the latent space 40 having a range of [−3, 3] corresponding to six Gaussian deviations. These outputs are received by the trained decoder 38. Thus, by varying the weights w_{M} of the material neural network 78, points in the latent space 40 are generated which can be provided to the trained decoder resulting in values of material parameters 16′.

With the introduction of the two neural networks of the geometry neural network 76 and material neural network 78, the weights w_{T} can, for example, control the cross-sectional areas A of the example truss elements, while the weights w_{M} may control the material parameters. In other words, the weights w_{T} and w_{M} now form the objective variables. Further, since geometry neural network 76 and material neural network 78 are designed to minimize an unconstrained loss function, the constrained minimization problem can be converted into an unconstrained minimization by employing a log-barrier scheme per Hoel Kervadec, Jose Dolz, Jing Yuan, Christian Desrosiers, Eric Granger, and I Ben Ayed, “Constrained deep networks: Lagrangian optimization via log-barrier extensions,” CoRR, abs/1904.04205, 2 (3): 4, 2019, hereby incorporated by reference.

In one embodiment, the analyzer 72 may use classical structural analysis to solve the state equation of the parametric model 12 per Larry J Segerlind, “Applied finite element analysis”, 1984, hereby incorporated by reference, and evaluate the performance of the parametric model 12 during each iteration. In the truss example, the analyzer 72 computes the stiffness matrix for each member based on the corresponding area, length, and material. Upon assembling the global stiffness matrix, a nodal displacement vector u maybe computed using a standard linear solver such as “torch.linalg.solve” in PyTorch per Adam Paszke et als., “Pytorch: An imperative style, high-performance deep learning library”, in Advances in Neural Information Processing Systems 32, pages 8024-8035, Curran Associates, Inc., 2019.

Part of the PyTorch library permits exploiting backward propagation for automatic differentiation per Aaditya Chandrasekhar, Saketh Sridhara, and Krishnan Suresh, “Auto: a framework for automatic differentiation in topology optimization”, Structural and Multidisciplinary Optimization, 64 (6): 4355-4365, December 2021. 33, resulting in an end-to-end differentiable solver with automated sensitivity analysis.

In one embodiment, the loss function used by the optimizing engine 70 is minimized using a gradient-based Adagrad optimizer per John Duchi, Elad Hazan, and Yoram Singer, “Adaptive subgradient methods for online learning and stochastic optimization”, Journal of machine learning research, 12 (7), 2011. Further, the sensitivities are computed automatically using back propagation.

Referring now to FIGS. 1, 2 and 3, upon completion of the joint optimization of geometric and material properties (as determined by a predetermined convergence criterion), at process block 90, the values of the optimized material properties defined by a coordinate in the latent space 40 are provided to the decoder 38 (or applied to a representation of the display of FIG. 3) to be matched to a closest actual material (represented by points 44 in FIG. 3) and being the first column in the catalog of materials 32.

The latent space 40 values for this closest actual material are then made constant and provided to the analyzer 72 so that the optimizing process can be repeated (analogously to the steps between process blocks 80 and 82) to repeat optimization of the geometric parameters 14′ with this fixed material parameter 16′.

Per process block 94 the resulting values are used to produce the optimized parametric model 12′ which may be output to the user for construction of the underlying structure for further analysis.

Referring now to FIG. 4, the invention may be implemented by an electronic computing system 100 having one or more processors 102 executing programs and operating on data stored in electronic memory 104 including the one or more programs 105 implementing the various components of the optimizer 20, data structures describing the various weights w_{E}, w_{D}, w_{T}, w_{M} (collectively 106), the parametric models 12, as well as other programs and data used in training of the neural networks and additional steps described above. The computing system 100 may communicate with a user terminal 108 providing a graphic display for the display of the representation of FIG. 3 and output values per process block 94 of FIG. 2, a separate processor and memory, keyboard, mouse, or other user input device, allowing the input of necessary input variables such as an objective function 22, constraints 24, and identification of objective variables 21 from the user as well as the development of the parametric model 12.

As used herein the terms geometry and geometric optimization and the like should be understood to broadly include not only the shape and sizing optimization of constrained configurations like struts described above, but more generally to topological optimization in which the shape and size may be fundamentally altered according to the objective function, a material distribution variable, and a design space generally describing a volume of the part.

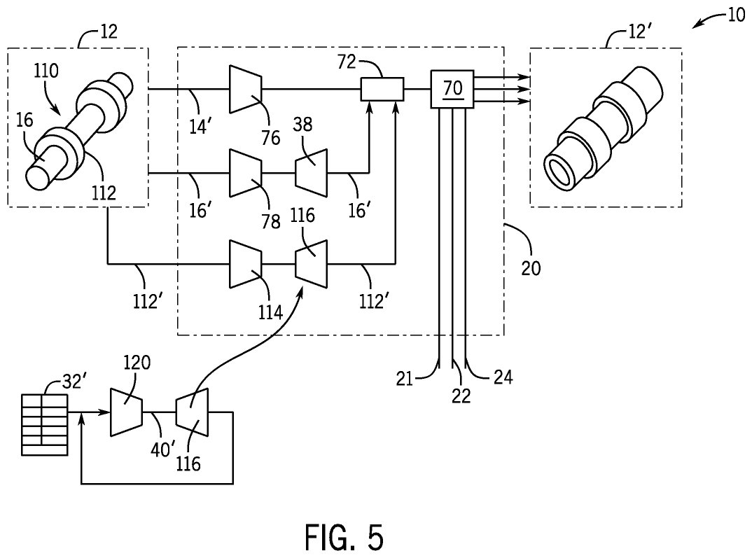

Referring now to FIG. 5, this process may be expanded to allow simultaneous optimization of discrete materials and discrete subassemblies such as bearings, springs, or the like. In this case, the parametric model 12, for example, a driveshaft assembly 110, may provide for geometric parameters 14 (for example, the length of the driveshaft), material parameters 16 (for example, the material of the driveshaft), and subassembly parameters 112, (for example, bearing types such as roller bearings or ball bearings). Variations in these values provide objective variables 21 that may be used to construct an objective function 22, for example, related to weight, strength, cost, or the like.

In this embodiment, the subassembly parameters 112 are provided to a subassembly neural network 114 operating analogously to material neural network 78, and a decoder 116 operating analogously to decoder 38 described above. The weights used by the subassembly neural network 114 are trained with a catalog of components 32′, for example, representing commercially available bearings (roller bearings, ball bearings, etc., and their dimensions and operating characteristics) and may be developed using an encoder 120 and decoder 116 (analogous to encoder 36 and decoder 38 discussed above) and trained similarly. Additional pairs of subassembly neural networks 114 and decoders 116 may be added for each subassembly, for example, for a subassembly of a driveshafts trained on a catalog of commercially available driveshafts (driveshaft diameter, tubular or solid driveshafts, etc.).

The optimizer 20 may then work in an iterative fashion, indicated as discussed above, by process blocks 80 and 82 and iteration loop 84 of FIG. 2, adjusting both material and subassembly neural net weights at process block 88. For this purpose, the optimizer 20, in conjunction with the analyzer 72, receives the current iteration of the geometric parameters 14′, the material parameters 16′, and the subassembly parameters 112′ and determines a value of the objective function that will be maximized by the optimizing engine 70.

Referring now to FIGS. 2, 3, and 5, upon completion of the joint optimization of geometric, material properties, and subassembly properties (as determined by a predetermined convergence criterion), at process block 90, the values of the optimized material properties defined by a coordinate in the latent space 40 and the optimize subassembly properties defined by a coordinate in the latent space 40′ are provided to the decoder 38 (or applied to a representation of latent space per the display of FIG. 3) to be matched to a closest actual material and subassembly from the respective catalogs 32 and 32′.

The values of the latent spaces 40 and 40′ may then be made constant, as reflected by the closest match with the values, and provided to the analyzer 72 so that the optimizing process can be repeated (analogously to the steps between process blocks 80 and 82) to repeat optimization of the geometric parameters 14′ with this fixed material parameter 16′.

Per process block 94, the resulting optimized values are used to produce the optimized parametric model 12′ which may be output to the user for construction of the underlying structure or for further analysis. Importantly, simultaneous optimization of geometry, material, and subassemblies can lead to optimal solutions that will not be reached when these optimizations are done sequentially.

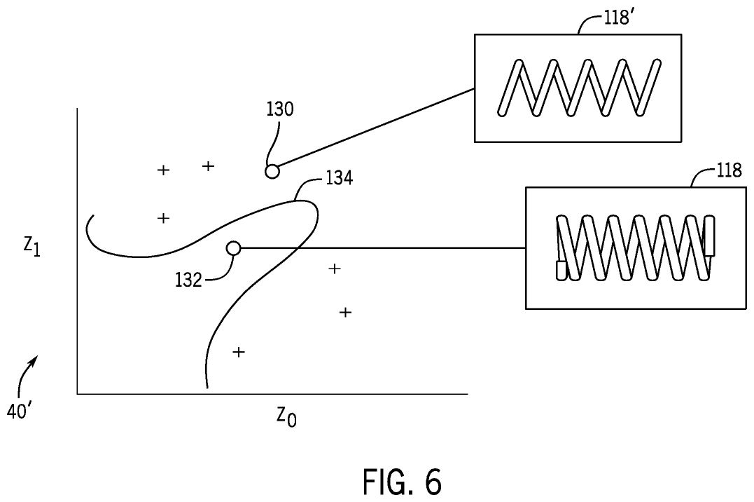

Referring now to FIG. 6, in the initial optimization, the optimized coordinate 130 in latent space 40′ may also be recorded and used to help develop new product offerings through a generative process in which the point 130 in latent space 40′ is provided to the decoder 116 to develop specifications for a new product offering, for example, a new spring design 118′ (defined parametrically) that matches designs frequently or historically representing optimizations in this process. This new design can be used to fill out a product catalog or offering.

A display of the latent space 40′ may be used to develop a range of products 118, for example, by selecting points 132 in latent space 40′ located away from other points representing actual products, or by superimposing contour lines 134 for a particular design feature (for example, spring rate) in the latent space 40 to generate products 118 for a variety of different design alternatives that provide the desired design feature.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” arc intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

What we claim is:

1. An optimizer for physical structures having an assembly of subassemblies constructed of materials and comprising:
a parametric model of the assembly having geometric parameters to be optimized;
a first machine learning decoder having weights trained with a training set having a first dimension of multiple subassembly parameters of multiple different mechanical subassemblies received by an encoder to encode the multiple subassembly parameters as a first differentiable representation having a second dimension smaller than the first dimension, the first machine learning decoder operating to receive the differentiable representation to decode the subassembly parameters;
a second machine learning decoder having weights trained with a training set having a first dimension of multiple material parameters of multiple different materials received by an encoder to encode the multiple material parameters as a second differentiable representation having a second dimension smaller than the first dimension, the second machine learning decoder operating to receive the differentiable representation to decode the material parameters; and
an optimizer employing the parametric model, an objective function, and one or more constraints to vary the geometric parameters and decoded material parameters applied to the parametric model to optimize the geometric parameters and material of the assembly.

2. The optimizer of claim 1 further including a first catalog of subassemblies linked to multiple subassembly parameters and a second catalog of materials linked to multiple material parameters and wherein the optimizer employs a first step of optimizing the subassembly parameters of the given structure to a first coordinate in the first differentiable representation and optimizing the material parameters of the given structure to a second coordinate in the second differentiable representation, and a second step of identifying a closest subassembly to the first coordinate and a closest material to the second coordinate from the first and second catalogs of materials respectively.

3. The optimizer of claim 2 wherein the optimizer performs a third step of using the parametric model and objective function and one or more constraints to optimize physical dimensions of the given structure using the material parameters of the closest material and the subassembly parameters of the closest subassembly.

4. The optimizer of claim 2 further including outputting a display representing the differentiable representation with materials of the first catalog superimposed on that representation at corresponding locations in the differentiable representation.

5. The optimizer of claim 2 further including outputting a display representing the differentiable representation with subassemblies of the second catalog superimposed on that representation at corresponding locations in the differentiable representation.

6. The optimizer of claim 1 wherein the first catalog of subassemblies provides subassembly parameters selected from the group of bearings, springs, and fasteners.

7. A mechanical subassembly synthesis apparatus comprising:
a machine learning decoder having weights trained with a training set having a first dimension of multiple subassembly parameters of multiple different subassemblies received by an encoder to encode the multiple subassembly parameters as a differentiable representation having a second dimension smaller than the first dimension, the machine learning decoder operating to receive the differentiable representation to decode the subassembly parameters; and
an electronic computer receiving a coordinate of the differentiable representation and appling it to the machine learning decoder to provide subassembly parameters.

8. The mechanical subassembly synthesis apparatus of claim 7 wherein the electronic computer further displays a visual representation of the differentiable representation and receives a coordinate identified with respect to the visual representation.

9. The mechanical subassembly synthesis apparatus of claim 8 wherein the visual representation further includes a display of a particular subassembly parameter value mapped to the differentiable representation.

10. The mechanical subassembly synthesis apparatus of claim 7 wherein the second catalog of subassemblies provides subassembly parameters selected from the group of bearings, springs, and fasteners.
